(19) United States
(12) Patent Application Publication
(10) Pub. No.: US 2008/0249186 A1
(43) Pub. Date: Oct. 9, 2008

(54) Fungicidal Composition

(75) Inventors: Thomas McGee, Nyack, NY (US); Rodrigo Rodriguez-Kabana, Auburn, AL (US); Andreas Natsch, Uetikon (CH)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 12/089,965

(22) PCT Filed: Oct. 9, 2006
(86) PCT No.: PCT/CH2006/000557

§ 371 Date: Jun. 23, 2008

Related U.S. Application Data
(60) Provisional application No. 60/726,734, filed on Oct. 14, 2005.

(51) Int. Cl. A01N 41/12; A01P 3/00

(52) U.S. Cl. 514/707

(57) ABSTRACT

A fungicidal preparation comprising:
(i) a fungicidal composition consisting essentially of
   (a) at least one allyl sulfide; and
   (b) at least one alkyl or alkenyl benzene substituted with at least one group selected from the group consisting of hydroxy, alleoxy, and oxo groups;
   in a weight ratio of (a) to (b) is from 1:0.5 to 1:19; and optionally
(ii) one or more further constituents is disclosed.

The fungicidal preparation preferably includes essential oils such as garlic, clove and thyme oils. Also provided are methods for producing said fungicidal preparations, as well as methods of use for the fungicidal preparations.

This invention relates to the field of pesticide control, and, in particular to compositions and methods useful for controlling pests and fungi, especially on seeds and plants.

A variety of plant pests, such as insects, worms, fungi, and plant pathogens such as viruses and bacteria, are known to cause significant damage to seeds and ornamental and crop plants. Chemical pesticides have generally been used, but most of these are expensive and toxic to humans or animals and/or the environment and persist long after they are applied. As a result, many pesticides are being phased out. The US Federal Insecticide, Fungicide and Rodent Act (FIFRA) defines a “pesticide” as “(1) any substance or mixture of substances intended for preventing, destroying, repelling, or mitigating any pest, (2) any substance or mixture of substances intended for use as a plant regulator, defoliant, or desiccant, and (3) any nitrogen stabilizer. In 1996, the US Environmental Protection Agency (EPA) exempted certain minimum risk pesticides from the FIFRA requirements if they satisfy certain conditions, in order to focus on pesticides that pose greater risk to humans and the environment. The actives in the list include several essential oils and their active ingredients.

Essential oils have been used since ancient times as pesticides. Many publications show the fungicidal properties of essential oils and their components, (for example: Maruzzella J. C. and Liguori, L (1958) “The in-vitro anti-fungal activity of essential oils”, J. Am. Pann. Assoc, 45, 250; Maruzzella J. C, Charamone J. S. and Arofolo M. M. (1961) “Effects of vapours of aromatic chemicals on fungi”, J. Pharm. Sci., 50, 665-668; Maruzzella J. C (1960) “The antifungal properties of essential oil vapours”. A review of the early literature on essential oils and fragrance materials as antimicrobials is given in: “Aroma Preservatives: Essential Oils and Fragrances as Antimicrobial agents”, ed. J. J. Kabara, Marcel; Decker New York (1984). Since these early studies were made, hundreds of other papers have been published on the antimicrobial effects of essential oils and their components.

Garlic, for example, has been used for many years as an animal and insect repellent and its antimicrobial properties have been extensively studied. Its commercial success, as an agricultural pesticide, has been limited due to its relatively low efficacy.

Other natural extracts have also been used as antifungal agents, for example, U.S. Pat. No. 5,129,951, discloses that the oxygenated monoterpenes cineole, fenchone and menthol, as well as several aromatic aldehydes and alcohols, including thymol, hydrocinnamaldehyde, cuminaldehyde, salicylaldehyde, cinnamaldehyde, and benzaldehyde, may be advantageously used to inhibit fungal growth. U.S. Pat. No. 6,482,455 claims a composition comprising eugenol, one or both of thymol and cinnamaldehyde; and an oligosaccharide, wherein the eugenol, the one or both of thymol and cinnamaldehyde and the oligosaccharide are present in the composition in an amount sufficient to inhibit the growth of pathogens and control chemical degeneration of the surface of a fruit or vegetable. Similarly products based on these essential oils are not efficacious enough.

Routes to improving this have been sought. For example, U.S. Pat. No. 6,548,085 claims a combination of an citrus oil and a synergist (sodium lauryl sulphate) and an essential oils, such as garlic as a synergistic insecticide; U.S. Pat. No. 6,6231,865 claims synergistic mixture of garlic and either cotton seed oil and cinnamon oil as a natural insecticide for inhibiting the growth of insects. The garlic extract used is obtained by blending and mixing of garlic cloves with water, oil or organic solvents. U.S. Pat. No. 6,511,674 recognizes that one of the reasons for poor commercial success is the low level of garlic in the extracts claimed to be effective. This patent teaches the use of a garlic extract solution, having a quantifiable concentration of greater than ten percent by weight of a garlic extract and a second component comprising an agricultural treatment agent of one of a pesticide, miticide, fungicide, anti-biotic, herbicide, defoliant, nutrient, adjuvant, and water.

There is still a need to maximise the efficacy of less toxic essential oils or their components for use as agricultural fungicides.

It has now been found that enhanced efficacy is possible by a combination of the active components of some essential oils in particular proportions. In one aspect, the invention therefore provides a fungicidal composition consisting essentially of

(a) at least one allyl sulfide; and

(b) at least one alkyl or alkenyl benzene substituted with at least one group selected from the group consisting of hydroxy, alleoxy, and oxo groups;

in a weight ratio of (a) to (b) of from 1:0.5 to 1:19.

In a further aspect, the present invention provides a fungicidal preparation comprising a fungicidal composition consisting essentially of

(a) at least one allyl sulfide; and

(b) at least one alkyl or alkenyl benzene substituted with at least one group selected from the group consisting of hydroxy, alleoxy, and oxo groups;

in a weight ratio of (a) to (b) of from 1:0.5 to 1:19, and optionally, one or more further constituents.

In a further aspect, the invention also provides a method of preventing or inhibiting fungal growth on plants, comprising the application thereto of an effective quantity of a fungicidal composition as hereinabove described.

It has been discovered that the combination of alkyl or alkenyl benzenes with allyl sulfides, such as diallyl sulfide (DAS), diallyl disulfide (DADS), diallyl trisulfide (DATS) and diallyl tetrasulfide (DATTS) gives a quite unexpectedly superior fungicidal activity against seed, air and soil-borne fungi. The increase in activity achieved by the combination is appreciably greater than the combined individual activities of the two components.

The substituted alkyl or alkenyl benzenes are preferably eugenol and thymol. They may be present as pure compounds, but in a preferred embodiment, they are contributed by essential oils such as clove oil or thyme oil.

The allyl sulfides may also be present as pure compounds, but, again, they are preferably contributed by essential oils, such as garlic oil.

In a further preferred embodiment the weight ratio of diallyl sulphides to the substituted alkyl or alkenyl benzenes is preferably from 1:1 to 1:4. When the substituted alkyl or alkenyl benzene is thymol, the most preferred range is from 1:2-1:4.

The composition can be utilized with any suitable carrier. The choice of will depend upon the method of application. Liquid carriers such as water can be used so that it can be applied as sprays and the like. In the case of water, if required, a suitable emulsifier/solvent could be employed. Preferably an EPA approved material such sodium lauryl sulphate. Other suitable liquids can be selected, preferably those on the EPA list of inerts, for example soybean oil. Solid carriers may also be considered, which may make application of the fungicidal mixture of this invention easier to apply and help the composition not soak into the ground or be washed away. Preferred carriers, for ecological reasons, would be naturally occurring ones and ones which can adsorb the oil mixture. More preferred would be those on the EPA list of approved inert ingredients; for example, almond hulls, corn cobs bentonite clay, bone meal, calcite, dolomite, granite, gypsum, kaolinite clay, montmorillonite clay, peanut shells, rice hulls, shale, soybean hulls, vermiculite, walnut shells and the like. The particle size of the carrier is selected to be most suitable for the method of application. The level of the composition of the invention in the carrier will be selected a specific application. The composition may be mixed with less volatile materials, preferably those on the EPA list such as beeswax, glycerol, linseed oil, corn oil or soybean oil to slow down the evaporation rate.

For longer-lasting protection, the composition may also be incorporated into controlled release systems. Many of these are known in the art. Preferred would be particles that are spray dried or agglomerated using core materials on the EPA list of inerts, for example dextrose, sodium chloride and the like.

Another preferred control system would be capsules that are biodegradable an on the EPA approved list of inerts, such as capsule made out of gelatine.

A most preferred embodiment is where the capsule has a hydrogel shell and an oily core, the garlic and substituted alkyl or alkenyl benzenes being loaded to blank capsules in the presence of water. Such capsules are described, for example, in U.S. Pat. Nos. 6,045,835 and 6,106,875, the contents whereof are incorporated herein by reference. Blank capsules of this type are available commercially from Givaudan Flavors Corp.

It can also be envisaged that the composition may be applied as part liquid and part carrier.

The invention is further described with reference to the following examples, in which all parts, percentages and ratios are by weight.

### EXAMPLES

### Example 1

### Synergism Determination

A test system was set up with two of most common soil inhabitating plant pathogenic fungi causing high losses in green houses: Fusarium oxysporum, and Rhizoctonia solani. Garlic oil was used as the source of allyl sulphides. Analysis showed the following composition of garlic oil:

| | |
|---|---|
| diallyl sulfide (DAS) | 8.0% |
| diallyl disulfide (DADS) | 37.9% |
| diallyl trisulfide (DATS) | 31.6% |
| diallyl tetrasulfide (DATTS) | 6.8% |

The synergistic action between this oil and eugenol or thymol was tested in Checkerboard titration experiments. The ‘checkerboard’ is the inhibitory pattern found for multiple combinations of two antimicrobial agents in concentrations equal to, above, and below their minimal inhibitory concentration for the organism being tested. These multiple combinations of antimicrobial agents are prepared in microtiter plates. The checkerboard consists then of columns which contain the same amount of one antimicrobial which is diluted along the x-axis and rows which each contain the same amount of the other antimicrobial (diluted along the y-axis). Thus, each well of the microtiter plate is a unique combination of the two agents.

A method of quantitating synergy is the ‘fractional inhibitory concentration’ (FIC) index. For each row, the FIC index is calculated from the lowest concentration of agents necessary to inhibit growth. The FIC of each agent is derived by dividing the concentration of the agent present in that well of the microtiter plate by the minimal inhibitory concentration (MIC) needed of that agent alone to inhibit the organism. The FIC index is then the sum of these values for both antibacterial agents in that well of the microtiter plate. Fractional inhibitory concentration indices are then used as measure of synergy. The FIC index is calculated for each row as follows:

$$FICindex = \frac{MICa}{MICA} + \frac{MICb}{MICB}$$

where MICa, MICb are the minimal inhibitory concentration (MIC) of compound A and B in the mixture, and MICA, MICB are the MIC of A and B when used alone. When the lowest FIC index obtained in a microtiter plate in this way is less than 1, the combination is synergistic. When the FIC index is 1, the combination is additive. For example, an FIC of 0.75 shows ½ MIC of one material can be combined with ¼ MIC of the other material.

All examples were made using routine techniques for MIC determination. The dilutions of the active agents were prepared in dimethylsulfoxide, and 2 μl aliquots of the different stock solutions of each of the two agents were then added to individual wells of the microtiter plates to obtain the desired checkerboard as described above. Fungi were swabbed from agar plates and suspended in 10 ml of Sabouraud liquid medium. The fungal suspensions was diluted 20 fold in the same growth medium. To each well of the microtiter plates 100 μl of such a diluted suspension of the test organism was distributed. The plates were covered with plastic films and incubated for 48 h at 30° C. with shaking at 250 rpm. The turbidity was then measured with a microplate reader to determine fungal growth.

The FIC values of mixtures are shown below:

| | F. oxysporum | F. oxysporum | |
|---|---|---|---|
| | (1st. replicate) | (2nd replicate) | R. solani |
| Garlic oil - Eugenol | 0.5-0.625 | 0.625 | 0.75 |
| (4-hydroxy-3-methoxy- | | | |
| 1-allylbenzene) | | | |
| Garlic oil - Thymol | 0.5-0.625 | 0.5 | 1 |
| (1-methyl-3-hydroxy-4- | | | |
| iso-propylbenzene) | | | |

The effects of garlic and eugenol are sysnergistic for both F. oxysporum and R. solani.

The effects of garlic and thymol is additive on R. solani, whereas on F. oxysporuin synergy is exhibited. Thus garlic is able to combine with materials that are fungistatic to provide a surprisingly effective system.

### Example 2

### Specific Active Combinations

Using the above method the active combinations of garlic oil with other ingredients were compared to the minimal inhibitory concentration (MIC) of the pure compounds: MIC of pure compounds:

| | F. oxysporum | R. solani |
|---|---|---|
| Garlic oil | 0.018% | 0.003% |
| eugenol | 0.05% | 0.025% |
| thymol | 0.05% | 0.0125% |

Active synergistic combinations inhibiting fungal growth:

| Target | | | |
|---|---|---|---|
| organism | Conc. Garlic oil | Compound B | conc B |
| F. oxysporum | 0.006% | Eugenol | 0.0125% |
| | (0.005% allyl sulfides) | | |
| F. oxysporum | 0.006% | Thymol | 0.0125% |
| | (0.005% allyl sulfides) | | |
| F. oxysporum | 0.0015% | Eugenol | 0.025% |
| | (0.0013% allyl sulfides) | | |
| F. oxysporum | 0.0015% | Thymol | 0.025% |
| | (0.0013% allyl sulfides) | | |
| R. solani | 0.0015% | Eugenol | 0.006% |
| | (0.0013% allyl sulfides) | | |

1. A fungicidal preparation comprising:
(i) a fungicidal composition consisting essentially of
(a) at least one allyl sulfide; and
(b) at least one alkyl or alkenyl benzene substituted with at least one group selected from the group consisting of hydroxy, alleoxy, and oxo groups;
in a weight ratio of (a) to (b) is from 1:0.5 to 1:19; and optionally
(ii) one or more further constituents.

2. A fungicidal preparation according to claim 1, in which the weight ratio of (a) to (b) is from 1:1 to 1:4.

3. A fungicidal preparation according to claim 1, in which the allyl sulphide is at least one of diallyl sulfide, diallyl disulfide, diallyl trisulfide and diallyl tetrasulfide.

4. A fungicidal preparation according to claim 1, in which the at least one allyl sulphide is provided by the use in the composition of garlic oil.

5. A fungicidal preparation according to claim 1, in which the at least one substituted alkyl or alkenyl benzene is selected from the group consisting of eugenol and thymol.

6. A fungicidal preparation according to claim 4, in which the eugenol and/or thymol is provided by the presence in the composition of a natural essential oil.

7. A fungicidal preparation according to claim 5, in which the essential oil is selected from clove oil and thyme oil.

8. A fungicidal preparation according to claim 7, in which the substituted alkyl or alkenyl benzene is thymol and the weight range is from 1:2-1:4.

9. A fungicidal preparation according to claim 1, in which the composition is loaded into gelatine capsules.

10. A fungicidal preparation according to claim 1, in which the composition is loaded into capsules having a a hydrogel shell and an oily core.

11. A fungicidal preparation according to claim 1, in which the composition is adsorbed on to a porous solid carrier substance.

12. A fungicidal preparation according to claim 11, in which the composition adsorbed on to the porous solid carrier substance is premixed into a high molecular weight, low melting point wax or solid.

13. A method of preventing or inhibiting fungal growth on plants, comprising the application thereto of an effective quantity of a fungicidal preparation according to claim 1.

14. A method according to claim 12, in which the fungicidal preparation is applied in solid form.

15. A method according to claim 14, in which the solid form is an encapsulated form.

16. A method according to claim 14, in which the solid form is provided by a solid porous material on to which the fungicidal preparation is adsorbed.

17. A method according to claim 16, in which the fungicidal preparation is premixed into a high molecular weight, low melting point wax or solid, prior to adsorption on to the solid.

18. A fungicidal composition consisting essentially of
(a) at least one allyl sulfide; and
(b) at least one alkyl or alkenyl benzene substituted with at least one group selected from the group consisting of hydroxy, alleoxy, and oxo groups;
in a weight ratio of (a) to (b) of from 1:0.5 to 1:19.

19. A method of preventing or inhibiting fungal growth on plants, comprising the application thereto of an effective quantity of a fungicidal composition according to claim 18.

20. A fungicidal composition comprising:
(a) at least one allyl sulfide; and
(b) at least one alkyl or alkenyl benzene substituted with at least one group selected from the group consisting of hydroxy, alleoxy, and oxo groups;
in a weight ratio of (a) to (b) of from 1:0.5 to 1:19.
